(19) United States
(12) Patent Application Publication
(10) Pub. No.: US 2015/0068115 A1
(43) Pub. Date: Mar. 12, 2015

(54) HYDRAULIC GROWTH MEDIUM AND MULCH

(71) Applicant: ORGANIC EARTH INDUSTRIES, INC., Fort Collins, CO (US)

(72) Inventors: J. Kevin Loucks, Fort Collins, CO (US); Roy Nelsen, Fort Collins, CO (US)

(73) Assignee: ORGANIC EARTH INDUSTRIES, INC., Fort Collins, CO (US)

(21) Appl. No.: 14/021,678

(22) Filed: Sep. 9, 2013

(51) Int. Cl. A01C 21/00; C05G 3/04

(52) U.S. Cl. CPC A01C 21/00; C05G 3/04
USPC 47/9; 71/23; 71/24

(57) ABSTRACT

Disclosed is a method for selection of constituents for a growth medium and mulch for varying types of soils. Also disclosed is a growth medium and mulch.

### FIELD OF THE INVENTION

The field of the invention relates generally to hydraulic growth mediums and mulch.

### BACKGROUND OF THE INVENTION

Hydraulic growth mediums and mulch are beneficial in recovering land, promoting regrowth of vegetation, long-term sustainability of vegetation while providing soil erosion control.

### SUMMARY OF THE INVENTION

An embodiment of the invention may therefore comprise a method of applying a growth medium and mulch to soil, said method comprising determining a first soil characteristic, determining a second soil characteristic, determining a third soil characteristic, selecting and mixing components of the growth medium and mulch based on the processes of determining a first soil characteristic, determining a second soil characteristic, and determining a third soil characteristic, and applying the selected and mixed components of the growth medium to soil.

An embodiment of the invention may further comprise a method of determining the constituents in a growth medium and mulch, said method comprising determining an erosive forces characteristic of a site, determining an organic matter content of soil characteristic at the site, determining a vegetation establishment difficulty characteristic at the site; and mixing the growth medium and mulch with an amount of constituents determined by a matrix of said erosive forces characteristic, said organic matter content of soil characteristic and said vegetation establishment difficulty characteristic.

An embodiment of the invention may further comprise a growth medium and mulch composition, said composition comprising a percentage of organic fibers, said percentage of organic fibers being determined by a plurality of site characteristics, and a percentage of growth mediums, said percentage of growth mediums being determined by a plurality of site characteristics.

### BRIEF DESCRIPTION OF THE DRAWINGS

FIG. 1 is a matrix for selection of growth medium and mulch components.

FIG. 2 is a flow diagram for selection of growth medium and mulch components.

### DETAILED DESCRIPTION OF THE EMBODIMENTS

Growth mediums and mulches may contain blends of different types of solutions and substances. These solutions and substances may include, for example, natural fibers, growth mediums and soil stabilizers. Natural plant and microbial growth stimulators may also be included in different solutions and substances. The natural plant and microbial growth stimulators may provide a multi-phased energy releasing system and method. Such a multi-phased energy releasing system and method will stage the release of nutrients to soil to provide an optimum growing environment with consistent nutrients during a general, or specific, time period.

A growth medium and mulch may comprise one or more types of organic fibers. The organic fibers may be of different sources and offer different characteristics to the growth medium and mulch. Different types of organic fibers may include, but are not limited to, thermally and mechanically processed wheat straw, defibrated wood, paper, cotton fibers and alfalfa meal.

Thermally and mechanically processed wheat straw may provide a source of erosion control cover. The same thermally and mechanically processed wheat straw may also provide an energy source in the manner of an organic matter for the microbes and soil system. Such a supply of organic matter may last up to 12 months and longer, depending on concentrations and particularities of the growth medium and mulch. It is understood that other straws may be used to substitute or mix with the wheat straw. It is also understood that particular compositions may alter depending on the characteristics of the other straw or mixture.

Defibrated wood may provide an erosion control cover secondary to the thermally and mechanically processed wheat straw. This secondary erosion control cover may be between the wheat straw fibers. The defibrated wood may similarly provide organic matter for microbes and the soil system. The energy source provided by defibrated wood may lapse a different time span that that of the straw. For instance, the defibrated wood may provide an energy source may last up to 24 months, and may begin offering energy some time after the wheat fiber has been supplying energy. Defibrated wood may also provide a mulching effect. The mulching effect provides seed germination and plant establishment benefits. Further, the defibrated wood may provide regulation of heat and moisture at the seedbed.

Paper may provide an erosion control cover secondary to the thermally and mechanically processed wheat straw. Paper also provides a more immediate energy source for the microbes aqnd soil system than that of the straw or defibrated wood. The energy source provided by paper may last up to 3 months or longer. Paper also provides seed germination and plant establishment benefits through the mulching effect of the paper. Further, paper may provide regulation of heat and moisture at the seedbed.

Cotton fibers provide a mechanical effect to growth medium and mulch. This mechanical effect may last up to 36 months or longer. The interlocking fibers of cotton are beneficial in binding the straw, wood and paper, or any combination of them, together. This binding effect makes the straw, wood, and paper more resistant to detachment and transportation which may occasion rainfall and runoff. Further, cotton fibers may provide an energy source via organic matter for the microbes and soil system that may last up to 36 months or longer.

Alfalfa meal provides a source of trace minerals, sugars, starches proteins, fiber and amino acids to a growth medium and mulch. The amino acids may include folic acid, vitamin A, triaconnatol and triacontanol growth stimulants.

A growth medium may be a compost. Compost provides an immediate growth medium for plants to establish and maintain their growth while the underlying soil is developed into a topsoil. A compost growth medium provides improved soils structure, porosity and density. Compost also aids in creating an improved plant root environment, increases permeability of heavy soils, reduces erosion and runoff and improves water holding capacity of sandy soils. Compost may also aid in reducing water loss and leaching, supply a variety of macro & micronutrients, control soil-borne plant pathogens, suppress soil-borne plant pathogens, supply an amount of organic matter, improve cat-ion exchange capacity of soils, and improve nutrient holding capabilities for plant use. Compost may also supply beneficial microorganisms to soils and improve and stabilize soil pH. Compost may also provide a fertilizing effect due to an overall positive and cumulative effect that it may have on soil nutrient levels. It is understood that there may be nutrients present in that soil and those nutrients may be made more bio-available to plants growing in soils with compost added. Composts may also improve the tilth of soil by improving the biodiversity. The biodiversity of the soil is improved when bacteria and fungi from the compost secrete colloidal “glues” which bind soil particles together in a water-absorbing matrix that aids soil in water retention and drainage. It is understood that among the uses, benefits and results of compost described above there may be other uses, benefits and results of compost understood and utilized by those skilled in the art.

A growth medium may be peat moss. Peat moss provides a secondary growth medium to soils. A benefit of peat moss may occur in contexts where plants can immediately grow. Peat moss also provides other benefits in addition to those of compost. Peat moss replaces lost organic matter in soils. Over time, peat moss provides organic and biological binders for improved soil aggregate formation. This allows for improved chances of pore space development in soils. Additionally, peat moss improves the Cat-ion Exchange Capacity (CET) which regulates nutrient flow in soils. Peat moss also may provide moisture holding properties and reduce the leaching of nutrients from the soil compared to compose. Peat moss is further less weighty than compost. Peat moss also provides a beneficial carbon nitrogen ratio. This carbon nitrogen ration indicates the stability of the soil supplement. For example, a low ratio may mean that the supplement is stable and will not draw down nutrients from the soil that plants need to grow. Peat moss also benefits from longevity, meaning it will last for extended periods, such as years, in the soil and continue to supplement the plants through the addition of humates. Peat moss also has beneficial bulk density, water holding capacity, air filled porosity, structure stability, pH, minimal salinity and limited to no pathogens, pests and weed seeds.

Soil stimulators and stabilizers may comprise guar, corn starch, linear polymers, super absorbent polymers, borax and mycorrhizae. Mycorrhizae is a beneficial fungus which aids in improving a soils health and establishing plant roots for areas that may experience drought or poor soil areas that may have minimal water holding capacity.

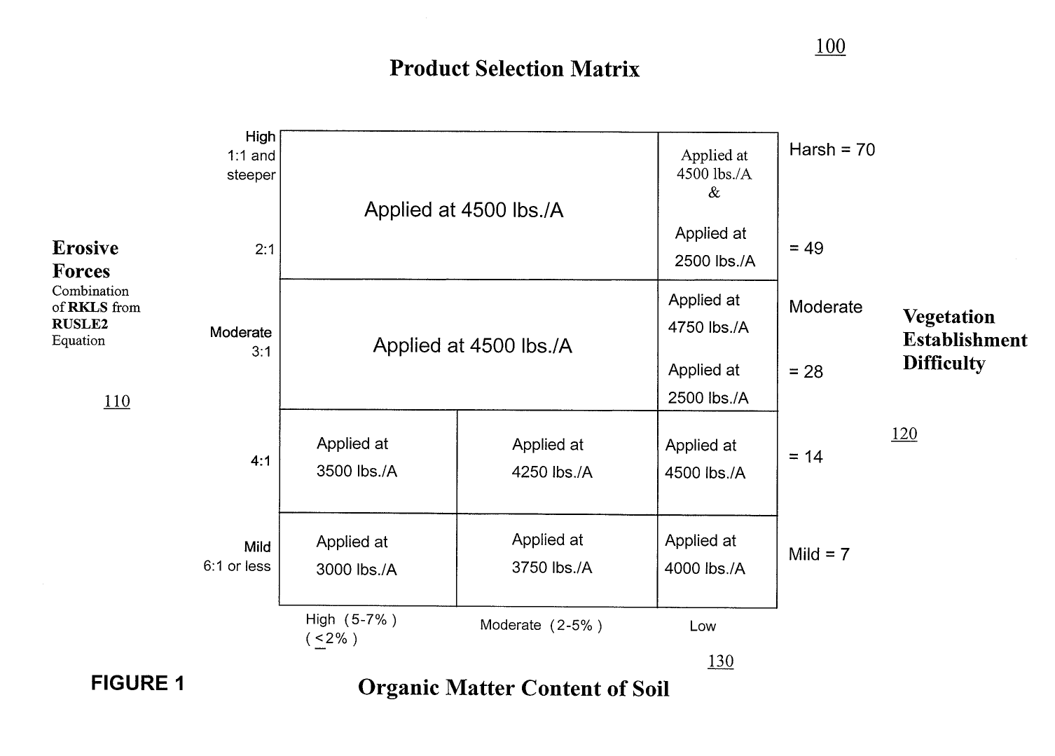

FIG. 1 is a matrix for selection of growth medium and mulch components. The matrix 100 shows a erosive force factor 110, a vegetation establishment difficulty factor 120 and an organic matter content of soil factor 130. The erosive forces factor 110 provides a scale from mild to moderate to high. The erosive forces factor 110 is scaled from 6:1 (mild) to 1:1 (steep and above). A particular soils erosive forces factor can be determined within this scale through use of a combination of RKLS from RUSLE2 equation. This combination is explained below.

The vegetation establishment difficulty 120 is scaled from mild to moderate to harsh. The vegetation establishment difficulty is determined by looking at various factors that affect the ability of vegetation to establish on a particular soil. These factors may include, but are not limited to, the amount of sunlight that a particular site may receive considering angles and other potential sun blockages, the slope aspect of site and expected or predicted precipitation or availability of irrigation to a site.

Organic matter content of soil 130 ranges on a scale from low to moderate to high in FIG. 1. The organic matter content of soil 130 is determined by measuring the organic content of a soil. It is understood that various methodologies and systems exist for measuring organic content. Any methodology or system may be used for such measurement.

As shown in FIG. 1, a variety of factors may be used to determine a proper mixture for a selected site. Those factors may include an erosive force factor, a vegetation establishment difficulty factor and an organic matter content of soil factor. The erosive forces factor provides a scale from mild to moderate to high. The erosive forces factor is scaled from, for instance, 6:1 (mild) to 1:1 (steep and above). A particular soils erosive forces factor can be determined within this scale through use of a combination of RKLS from RUSLE2 equation. This combination is explained below.

A combination of the materials listed above may ensure flocculation of soil particles into cohesive soil aggregates. A number of benefits arise from this:
Enhanced micro and macro pore space in soils
Prevention of soil crusting for improved water infiltration. Infiltration may increase up to 75% with more even wetting throughout soil profiles
Increased soil permeability from the formation of soil pore space
Assisting in establishing improved soil microbial activity
Improved root penetration
Migration of organics into soils for increased water holding capacities
Protection of soil colloids leading to reduced soil erosion
Increased crop emergence rates. This may increase by up to 35% or more.
Decreased nutrient lost by 90%, for example, by opening the pore space and allowing soil water and amendment interaction instead of removal by runoff
   Soil stabilizers and stimulators may also provide effective bonding of a mulch to itself and to a soil surface. Increased bonding effects occur when cotton fibers are combined with soil stabilizers and stimulators. The strength of these bonds is not lost with rainfalls due to bonding of the soil to itself to reduce its detachment and transportation. Guar and starch materials also provide an immediate and long-term sustained source of energy for soil microbes.

A variety of mixtures may result from using the factors outlined above. For instance, a particular site may indicate a high erosive force characteristic, a mild vegetation establishment difficulty characteristic and a moderate organic matter content of soil characteristic. There may also be a variety of application rates, such as 1500 lbs/acre or 6000 lbs/acre. These application rates can be used to accommodate a high erosive force and a mild vegetation establishment difficulty.

Several mixing ratios can be used as examples. For instance, a first product mixture may be applied at 2500 lbs/acre for a harsh vegetation establishment difficulty characteristic and a low organic matter content of soil. An example of Product mixtures is:

| Product | % of mix |
|---|---|
| Straw | 20-65 |
| Wood | 5-15 |
| Paper | 5-15 |
| Cotton | 1-5 |
| Compost | 10-50 |
| Peat | 1-10 |
| Alfalfa | 1-5 |
| Polymer | 0.01-3 |
| Guar | 1-7 |
| Starch | 0.01-5 |
| Super absorbent | 0.01-1 |
| polymer | |
| Borax | 0.01-1 |
| Mycorrhizae | 0.01-1 |

A second different product mix may be applied at 1500-4500 lbs/acre for a mild vegetation establishment difficulty and low organic matter content of soil.
Yet another third product mixture may be applied for a moderate erosive forces characteristic, or a moderate vegetation establishment difficulty characteristic and high to moderate organic matter content of soil.

The first mixture may be applied at 4750 lbs/acre for a low organic matter content of soil characteristic and a moderate erosive forces characteristic or a moderate vegetation establishment difficulty characteristic. The first mixture may also be applied at 2500 lbs/acre for an erosive forces characteristic or a high vegetation establishment difficulty characteristic.

A fourth product mixture may be applied at 4500 lbs/acre for high erosive forces characteristic and a high organic matter content of soil characteristic. It is understood that a variety of mixtures may result from an application of the matrix depending on site conditions and soil content and conditions. For example, the third mixture may be used under any rolled erosion control product (ECP) at lower rates as a soil amending material depending on soil conditions. Another mixture, a fifth product, may be used similarly. However, in another example, the fifth product may be suited to use as a replacement soil for infilling of turf reinforcement mats (TRMs) at a particular application rate, 4500 lbs/acre, for example.

Erosive forces characteristics may be determined by utilizing the slope gradients of a particular site. However, erosive force characteristics may also be calculated by utilizing the Revised Universal Soil Loss Equation Version 2 (RUSLE2) and then inserting the result in to an equation which utilizes the following factors: R=rainfall erosive energy, K=soil erodibility, L=slope length, and S=gradient.

The Vegetation Establishment Difficulty (VED) may be based on the site's environmental extremes that will limit potential vegetation establishment. Examples of these extremes may be the amount of sunlight a site receives which may in turn be affect by direction and climate, slope aspect, expected precipitation as well as other factors.

In an embodiment of the invention, the VED, Erosive Forces (EF) and Organic Matter Content of the Soil (OMCS) are determined and a mixture of growth medium and fibers is mixed according to those determinations. For situations, like noted above, where an EF and a VED calculation may result in differing mixtures applied at different rates, one or the other of the resulting mixtures and rates may be used. For instance a mild VED and a high EF for a low OMCS might result in different mixtures applied at different rates. In such situations, a determination can be made as to which characteristic to favor. In some cases, the mixtures may be altered to account for both EF and VED difficulties.

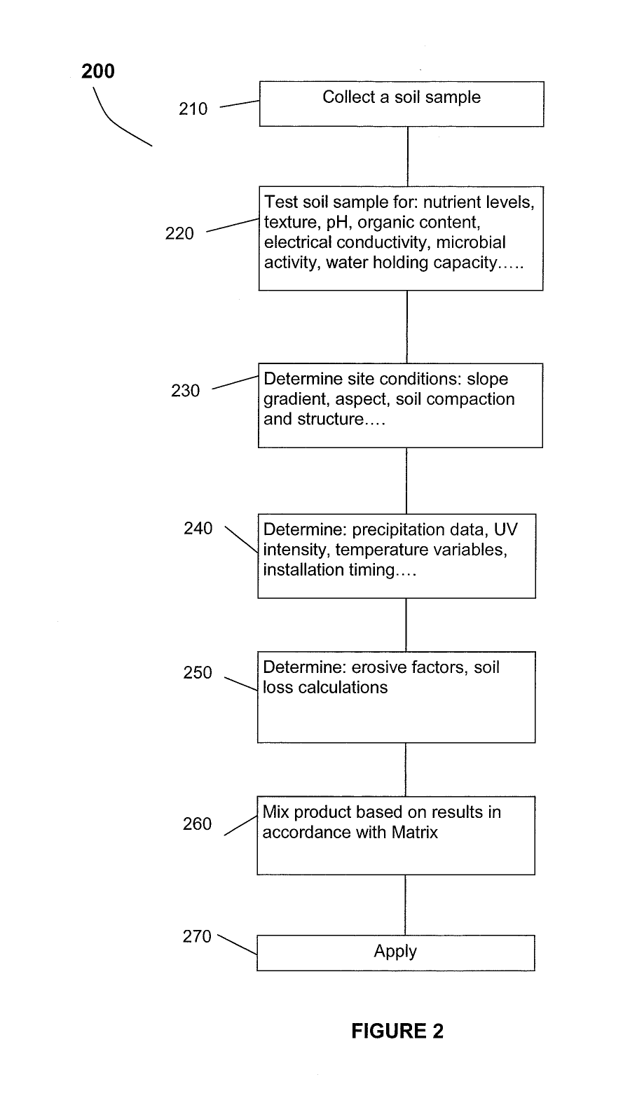

FIG. 2 shows a flow diagram for determining mixture contents. In the method 200, a first step is to collect a soil sample 210. A next step is to test the soil sample 220. The soil sample is tested for nutrient levels, texture, pH levels, organic content and any other characteristic that may be deemed important in determining a growth medium mixture. These may include electrical conductivity, microbial activity, water holding capacity and other factors. A next step is to determine sider conditions 230. Site conditions may include slope gradient, aspect, soil compaction and structure. Site condition day may then be determined 240. Site conditions may include precipitation data, UV intensity, temperature variables, installation timing and other factors. Erosive forces factors may then be determined 250. Erosive factors may be those that impact the site. The Erosive forces factors determination 250 may include slil loss calculations using the RUSLE2 modeling for the site with the various products. The product is then mixed based on the results of the above determinations 260.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of applying a growth medium and mulch to soil, said method comprising:
determining a first soil characteristic;
determining a second soil characteristic;
determining a third soil characteristic;
selecting and mixing components of the growth medium and mulch based on the processes of determining a first soil characteristic, determining a second soil characteristic, and determining a third soil characteristic; and
applying the selected and mixed components of the growth medium to soil.

2. The method of claim 1, wherein said selected and mixed components comprise one or more corrosion control fibers and one or more growth medium constituents.

3. The method of claim 2, wherein:
said erosion control fibers comprise processed wheat straw, defibrated wood, paper, cotton fibers; and
said growth medium constituents comprise compost and peat moss.

4. The method of claim 2, wherein said selected and mixed components further comprise one or more soil stimulators and stabilizers.

5. The method of claim 4, wherein:
said erosion control fibers comprise processed wheat straw, defibrated wood, paper, cotton fibers;
said growth medium constituents comprise compost and peat moss; and
said soil stimulators and stabilizers comprise guar, cornstarch, linear polymer, super absorbent polymer, borax and mycorrhizae.

6. A method of determining the constituents in a growth medium and mulch, said method comprising:
determining an erosive forces characteristic of a site;
determining an organic matter content of soil characteristic at the site;
determining a vegetation establishment difficulty characteristic at the site; and
mixing the growth medium and mulch with an amount of constituents determined by a matrix of said erosive forces characteristic, said organic matter content of soil characteristic and said vegetation establishment difficulty characteristic.

7. The method of claim 6, wherein said constituents comprise one or more corrosion control fibers and one or more growth medium constituents.

8. The method of claim 7, wherein:
said erosion control fibers comprise processed wheat straw, defibrated wood, paper, cotton fibers; and
said growth medium constituents comprise compost and peat moss.

9. The method of claim 7, wherein said selected and mixed components further comprise one or more soil stimulators and stabilizers.

10. The method of claim 9, wherein:
said erosion control fibers comprise processed wheat straw, defibrated wood, paper, cotton fibers;
said growth medium constituents comprise compost and peat moss; and
said soil stimulators and stabilizers comprise guar, cornstarch, linear polymer, super absorbent polymer, borax and mycorrhizae.

11. A growth medium and mulch composition, said composition comprising:
a percentage of organic fibers, said percentage of organic fibers being determined by a plurality of site characteristics; and
a percentage of growth mediums, said percentage of growth mediums being determined by a plurality of site characteristics.

12. The growth medium and mulch composition of claim 11, wherein:
said organic fibers comprise one or more of thermally and mechanically processed wheat straw, defibrated wood, paper, cotton fibers and alfalfa meal; and
said growth mediums comprise one or more of compost and peat moss.

13. The growth medium and mulch composition of claim 11, further comprising a percentage of soil stimulators and stabilizers, said percentage of soil stimulators and stabilizers being determined by a plurality of site characteristics.

14. The growth medium and mulch composition of claim 13, wherein:
said organic fibers comprise one or more of thermally and mechanically processed wheat straw, defibrated wood, paper, cotton fibers and alfalfa meal;
said growth mediums comprise one or more of compost and peat moss; and
said soil stimulators and stabilizers comprise guar, cornstarch, linear polymer, super absorbent polymer, borax and mycorrhizae.

15. The growth medium and mulch composition of claim 11, wherein said site characteristics comprise erosive forces, vegetation establishment difficulty and organic matter content of soil at a site.
